(19) United States
(12) Patent Application Publication
(10) Pub. No.: US 2021/0408524 A1
(43) Pub. Date: Dec. 30, 2021

(54) CATHODE ACTIVE MATERIAL FOR LITHIUM ION BATTERIES FOR ELECTRIC VEHICLES

(71) Applicant: GM GLOBAL TECHNOLOGY OPERATIONS LLC, Detroit, MI (US)

(72) Inventors: Mary E. Fortier, Troy, MI (US); Bing Tan, Ann Arbor, MI (US); Li Yang, Warren, MI (US); Uma Viswanathan, Troy, MI (US); Vijay P. Saharan, Grand Blanc, MI (US); Sherman H. Zeng, Troy, MI (US)

(73) Assignee: GM GLOBAL TECHNOLOGY OPERATIONS LLC, Detroit, MI (US)

(21) Appl. No.: 16/912,177

(22) Filed: Jun. 25, 2020

(51) Int. Cl. H01M 4/136; H01M 10/0525; H01M 4/131; H01M 4/36; H01M 4/505; H01M 4/58; H01M 4/62; B60L 50/60; B60K 1/04

(52) U.S. Cl. CPC H01M 4/136; H01M 10/0525; H01M 4/131; H01M 4/364; H01M 4/505; H01M 2004/028; H01M 4/625; H01M 4/622; B60L 50/66; B60K 1/04; H01M 2220/20; H01M 4/5825

(57) ABSTRACT

A lithium ion batteries and electric vehicles including lithium ion batteries are provided. An exemplary lithium ion battery includes a cathode including a cathode active material comprising at least 50 wt. %, based on a total weight of the cathode active material, of LiFeₓMn₍₁₋ₓ₎PO₄, wherein X is from 0.01 to 0.5.

### INTRODUCTION

The technical field generally relates to lithium ion battery cells for electric vehicles (EVs), and more particularly relates to cathode active material for EV batteries.

Secondary, or rechargeable, lithium ion batteries are used in many stationary and portable devices, such as those encountered in the consumer electronic, automobile, and aerospace industries. The lithium ion class of batteries has gained popularity for various reasons including a relatively high energy density, a general lack of any memory effect when compared to other kinds of rechargeable batteries, a relatively low internal resistance, and a low self-discharge rate when not in use. The ability of lithium batteries to undergo repeated charging-discharging cycling over their useful lifetimes makes them an attractive and dependable electrical energy source.

A lithium ion battery cell generally operates by reversibly passing lithium ions between a negative electrode (conventionally called the anode) and a positive electrode (conventionally called the cathode). The negative and positive electrodes are situated on opposite sides of an insulating microporous polymer separator that is soaked with an electrolyte solution suitable for conducting lithium ions. Each of the negative and positive electrodes is deposited, respectively, on a copper or aluminum current collector that also possesses a tab that ensures a connection to an external circuit via a battery terminal. The terminal is in turn connected into an interruptible external circuit that allows an electric current to pass on the outside of the battery to electrically balance the related migration of lithium ions inside the battery. In general, the positive electrode typically includes a lithium-based active intercalation material such as a lithium transition metal oxide, the negative electrode typically includes a lithium host material such as graphite that can store lithium at a lower energy state than can the active intercalation host material of the positive electrode, and the electrolyte solution typically contains a lithium salt dissolved in a non-aqueous solvent.

A lithium ion battery, or a plurality of lithium ion batteries that are connected in combination of series or parallel configurations or both can be utilized to supply electrical energy to an associated load device. When fully charged, the positive electrode of a lithium ion battery has a very low concentration of intercalated lithium while the negative electrode is correspondingly lithium-rich. Closing an external circuit between the negative and positive electrodes under such circumstances causes the extraction of intercalated lithium from the negative electrode. The extracted lithium is then split into lithium ions and electrons. Lithium ions are carried through the micropores of the polymer separator from the negative electrode to the positive electrode by the ionically conductive electrolyte solution while, at the same time, the electrons are transmitted through the external circuit from the negative electrode to the positive electrode to balance the overall electrochemical cell. At the same time, Li⁺ ions from the solution recombine with electrons at interface between the electrolyte and the positive electrode, and the lithium concentration in the active material of the positive electrode increases. The flow of electrons through the external circuit can be harnessed and fed to a load device until the level of intercalated lithium in the negative electrode falls below a workable level or the need for electrical energy ceases.

The lithium ion battery may be recharged after a partial or full discharge of its available capacity for charge storage. To charge the lithium ion battery, an external electrical energy source is connected to the positive and the negative electrodes to drive the reverse of battery discharge electrochemical reactions. That is, during charging, the external power source extracts the intercalated lithium present in the positive electrode to produce lithium ions and electrons. The lithium ions are carried back through the separator by the electrolyte solution and the electrons are driven back through the external circuit, both towards the negative electrode. The lithium ions and electrons are ultimately reunited at the negative electrode thus replenishing it with intercalated lithium for future battery discharge.

The ability of lithium ion batteries to undergo such repeated charge cycling over their useful lifetimes makes them an attractive and dependable electrical energy source. Lithium nickel manganese cobalt oxide, commonly referred to as “NCM”, is recognized by many as the best material for being used as cathode material for lithium ion batteries. Typically, the cathode material combination is about one-third nickel, one-third manganese and one-third cobalt.

As a result, there is an increasing demand for the elements used in the NMC cathode material. Nickel and cobalt are both limited in supply. Therefore, the production of NMC lithium batteries is vulnerable both to price increases in nickel or cobalt due to limited supply, or to stoppage due to interruptions in supply. This is exacerbated in the EV market where the cost of an EV is a primary concern for many customers.

Accordingly, it is desirable to provide cathode active material including alternative material that is less vulnerable to supply price increases or supply interruptions. Further, it is desirable to provide a lithium iron manganese phosphate oxide material as a cathode active material for lithium ion batteries for the EV market. Furthermore, other desirable features and characteristics of embodiments herein will become apparent from the subsequent detailed description and the appended claims, taken in conjunction with the accompanying drawings and the foregoing technical field and background.

### SUMMARY

Lithium ion batteries for electric vehicles and electric vehicles including lithium ion batteries are provided. An exemplary lithium ion battery for an EV includes a cathode including a cathode active material comprising at least about 50 wt. %, based on a total weight of the cathode active material, of LiFeₓMn₍₁₋ₓ₎PO₄, wherein X is from about 0.01 to about 0.5.

In an exemplary embodiment of the lithium ion battery for an EV, the cathode active material further comprises additional active material selected from LiMn₂O₄ and/or LiFePO₄.

In an exemplary embodiment of the lithium ion battery for an EV, the cathode active material further comprises additional active material selected from a lithium manganese oxide (LMO) material and a lithium iron phosphate (LFP) material, wherein the cathode active material comprises from about 50 to about 99 wt. % LiFeₓMn₍₁₋ₓ₎PO₄ and from 1 to about 50 wt. % of the additional active material, all based on a total weight of the cathode active material.

In an exemplary embodiment of the lithium ion battery for an EV, the cathode further comprises an inorganic conductive binder.

In an exemplary embodiment of the lithium ion battery for an EV, the cathode further comprises an inorganic binder and a binder resin, and the cathode comprises at least about 95 wt. % active material, at least about 1 wt. % carbon nanotube, and at least about 1 wt. % binder resin.

In an exemplary embodiment of the lithium ion battery for an EV, the cathode active material has a reversible capacity loading of not less than 4.0 mAh/cm².

In an exemplary embodiment of the lithium ion battery for an EV, the cathode active material has an electrode porosity of not greater than 35%.

In another embodiment, a lithium battery for EV is provided and includes a cathode including a cathode active material comprising a blended mixture of a lithium manganese oxide (LMO) material and LiFeₓMn₍₁₋ₓ₎PO₄, wherein X is at most 0.5; and wherein the cathode active material has a LiFeₓMn₍₁₋ₓ₎PO₄:LMO material mass ratio of from about 60:40 to about 95:5.

In an exemplary embodiment of the lithium battery for EV, the LMO material is LiMn₂O₄.

In an exemplary embodiment of the lithium battery for EV, X=0.2 and Y=0.8.

In an exemplary embodiment of the lithium battery for EV, the LiFeₓMn₍₁₋ₓ₎PO₄:LMO material mass ratio is from about 60:40 to about 70:30.

In an exemplary embodiment of the lithium battery for EV, the LiFeₓMn₍₁₋ₓ₎PO₄:LMO material mass ratio is from about 70:30 to about 80:20.

In an exemplary embodiment of the lithium battery for EV, the LiFeₓMn₍₁₋ₓ₎PO₄:LMO material mass ratio is from about 80:20 to about 95:5.

In yet another embodiment, an electric vehicle is provided and includes a vehicle chassis and a battery pack assembly including lithium ion cells. At least 50% of the lithium ion cells have a cathode including a cathode active material of at least about 50 wt. %, based on a total weight of the cathode active material, of LiFeₓMn₍₁₋ₓ₎PO₄, wherein X is from about 0.01 to about 0.5.

In an exemplary embodiment of the electric vehicle, at least 70% of the lithium ion cells have a cathode comprising the cathode active material.

In an exemplary embodiment of the electric vehicle, at least 90% of the lithium ion cells have a cathode comprising the cathode active material.

In an exemplary embodiment of the electric vehicle, the cathode active material comprises a blended mixture of a lithium manganese oxide (LMO) material and the LiFeₓMn₍₁₋ₓ₎PO₄; and wherein the cathode active material has a LiFeₓMn₍₁₋ₓ₎PO₄:LMO material mass ratio of from about 60:40 to about 95:5. Further, in an exemplary embodiment of the electric vehicle, the LMO material is LiMn₂O₄. Also, in an exemplary embodiment of the electric vehicle, X=0.2 and Y=0.8.

In an exemplary embodiment of the electric vehicle, the lithium ion cells have a cathode reversible capacity loading of greater than 4.0 mAh/cm², and wherein the lithium ion cells are operated at a temperature from about −30 to about 80° C.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic, perspective view of an electric vehicle with a cut-away section to reveal a battery pack assembly in accordance with an embodiment;

FIG. 2 is a schematic of an exemplary lithium ion battery that includes several adjacent electrochemical battery cells in accordance with an embodiment;

FIG. 3 is a schematic of an exemplary lithium ion battery cell in accordance with an embodiment; and

FIG. 4 is a schematic of cathode material, including cathode active material, in accordance with an embodiment.

### DETAILED DESCRIPTION

The following detailed description is merely illustrative in nature and is not intended to limit the embodiments of the subject matter or the application and uses of such embodiments. Any implementation described herein as exemplary is not necessarily to be construed as preferred or advantageous over other implementations. Furthermore, there is no intention to be bound by any expressed or implied theory presented in the preceding technical field, background, brief summary or the following detailed description.

As used herein, the word “exemplary” means “serving as an example, instance, or illustration”. As used herein, “a,” “an,” or “the” means one or more unless otherwise specified. The term “or” can be conjunctive or disjunctive. Open terms such as “include,” “including,” “contain,” “containing” and the like mean “comprising.” In certain embodiments, numbers in this description indicating amounts, ratios of materials, physical properties of materials, and/or use are may be understood as being modified by the word “about”. The term “about” as used in connection with a numerical value and the claims denotes an interval of accuracy, familiar and acceptable to a person skilled in the art. In general, such interval of accuracy is ±10%. All numbers in this description indicating amounts, ratios of materials, physical properties of materials, and/or use may be understood as modified by the word “about,” except as otherwise explicitly indicated. As used herein, the “%” or “percent” described in the present disclosure refers to the weight percentage unless otherwise indicated. Further, terms such as “above,” “below,” “upward,” “downward,” et cetera, are used descriptively of the figures, and do not represent limitations on the scope of the subject matter, as defined by the appended claims. Any numerical designations, such as “first” or “second” are illustrative only and are not intended to limit the scope of the subject matter in any way. Further, the term “cathode” as used herein is provided with the conventional understanding of “positive electrode” in a lithium ion battery or cell where lithium ions are passed between a negative electrode (conventionally called the anode) and the cathode.

Embodiments herein are related to cathode active material including lithium iron manganese phosphate oxide (LFMP), such as for use in cathodes of lithium ion battery cells, to batteries including lithium ion battery cells with the LFMP cathode active material, and to devices such as electric vehicles utilizing such batteries. As compared to lithium batteries using nickel cobalt manganese oxide (NCM), embodiments herein rely on more abundant and less costly raw materials. As compared to lithium batteries using lithium manganese oxide (LMO) and/or lithium iron phosphate oxide (LFP), embodiments herein have a higher energy density.

Referring now to FIG. 1, an electric vehicle 1 having a high voltage battery pack assembly 7 provided with a battery module 2 is shown. The exemplary battery module 2 includes a plurality of lithium ion batteries. Further, the battery pack assembly 7 may include a plurality of battery modules 2. Also, while FIG. 1 illustrates a battery module 2, it is envisioned that the battery pack assembly 7 may not include any battery module 2, such as in a cell-pack design. The exemplary electric vehicle 1 includes a vehicle chassis 3 and a battery tray 4. In the illustrated embodiment, the battery module 2 attaches to the battery tray 4. Further, the battery tray 4 attaches to the vehicle chassis 3 to secure the pack assembly 7 to the electric vehicle 1.

The exemplary electric vehicle 1 may also include a battery disconnect unit (BDU) 5, which is connected to the pack assembly 7 and provides electrical communication between the pack assembly 7 and an electrical system (not shown) of the electric vehicle 1. The exemplary electric vehicle 1 may further include a battery cover 6 that extends around the battery module 2. The exemplary battery cover 6 may protect the battery module 2 from being damaged, as well as provide electrical insulation from the high voltage of the battery pack assembly 7.

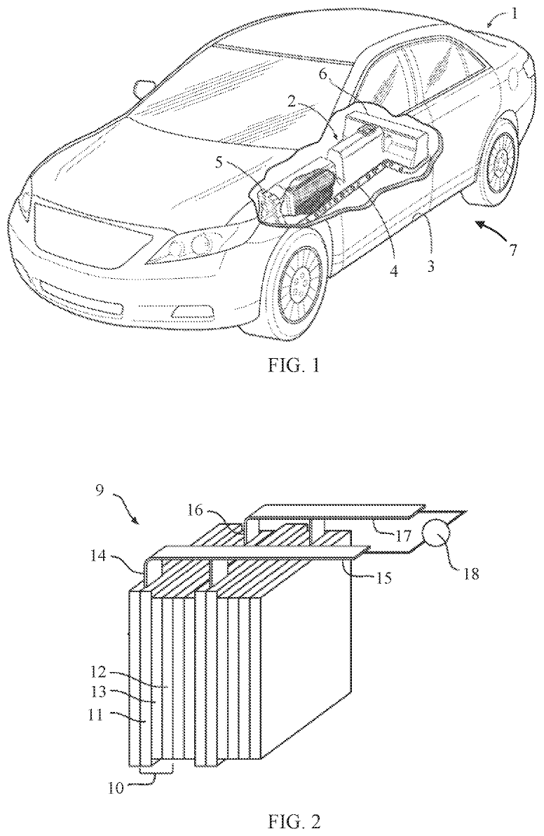

FIG. 2 illustrates an exemplary and generalized lithium ion battery 9 included in the battery pack assembly 7 of FIG. 1. In FIG. 2, the lithium ion battery 9 is shown to include several rectangular-shaped electrochemical battery cells 10 that are each bracketed by metallic current collectors. The electrochemical battery cells 10 are stacked side-by-side in a modular configuration and connected in series (although a parallel connection is also permitted). The lithium ion battery 9 can be connected serially or in parallel to other similarly constructed lithium ion batteries to form a lithium ion battery pack that exhibits the voltage and current capacity demanded for a particular application. It should be understood the lithium ion battery 9 shown here is only a schematic illustration. FIG. 1 is meant to show the relative position and physical interactions of the various components that constitute the electrochemical battery cells 10 (i.e., the electrodes and the separator); it is not intended to inform the relative sizes of the electrochemical battery cells' components, to define the number of electrochemical battery cells 10 in the lithium ion battery 9, or to limit the wide variety of structural configurations the lithium ion battery 9 may assume. Various structural modifications to the lithium ion battery 9 shown in FIG. 1 are possible despite what is explicitly illustrated.

The electrochemical battery cell 10 contained in the lithium ion battery 9 includes a negative electrode 11, a positive electrode 12, and a separator 13 situated between the two electrodes 11, 12. Each of the negative electrode 11, the positive electrode 12, and the separator 13 is wetted with a liquid electrolyte solution that is able to communicate lithium ions. A negative-side metallic current collector including a negative polarity tab 14 is located between the negative electrodes 11 of adjacent electrochemical cells 10. The negative polarity tab 14 is electrically coupled to a negative terminal 15. Likewise, a positive-side metallic current collector including a positive polarity tab 16 is located between neighboring positive electrodes 12. The positive polarity tab 16 is electrically coupled to a positive terminal 17.

The electrochemical cell 10 is generally thin and flexible. A typical thickness of the electrochemical cell 10 extending from the outer face surface of the negative electrode 11 to the outer face surface of the positive electrode 12 is about 80 μm to about 350 μm. Each electrode 11, 12 is may be from about 30 μm to 150 μm thick and the separator 13 may be from about 20 μm to 50 μm thick. The metallic current collectors are normally about 5 μm to 20 μm thick. The relatively thin and flexible nature of the electrochemical battery cell 10 and its associated metallic current collectors allows them to be rolled, folded, bent, or otherwise maneuvered into a variety of lithium ion battery configurations depending on design specifications and spatial constraints. The lithium ion battery 9 may, for example, include a number of distinct electrochemical battery cells 10 that have been fabricated, cut, aligned, and positioned next to one another or, in an alternative embodiment, the cells 10 may be derived from a continuous layer that is folded back-and-forth over itself many times.

The negative electrode 11 includes a lithium host material that stores inserted lithium at a relatively low electrochemical potential (relative to a lithium metal reference electrode) such as, for example, graphite or lithium titanate. The negative electrode may include other anode active materials selected from graphite, tin, silicon, silicon oxide, antimony, phosphorus, lithium, hard carbon, soft carbon, and mixtures thereof. The lithium host material may be intermingled with a polymeric binder material to provide the negative electrode 11 with structural integrity. An exemplary lithium host material is graphite and an exemplary polymeric binder material is one or more of polyvinyldiene fluoride (PVdF), an ethylene propylene diene monomer (EPDM) rubber, or a carboxymethoxy cellulose (CMC). Graphite is normally used to make the negative electrode 11 because, on top of being relatively inert, its layered structure exhibits favorable lithium intercalation and deintercalation characteristics which help provide the electrochemical battery cell 10 with a suitable energy density. The negative-side metallic current collector associated with the negative electrode 11 is preferably a thin-film copper foil that coextensively contacts the outer face surface of the negative electrode 11.

The positive electrode 12 includes a lithium-based active material that stores intercalated lithium at a higher electrochemical potential than the lithium host material used to make the negative electrode 11 (also relative to a lithium metal reference electrode). The same polymeric binder materials that may be used to construct the negative electrode 11 (PVdF, EPDM, CMC) may also be intermingled with the lithium-based active material to provide the positive electrode 12 with structural integrity. The lithium-based active material is preferably a layered lithium transition metal oxide, such as lithium cobalt oxide (LiCoO₂), a spinel lithium transition metal oxide, such as spinel lithium manganese oxide (LiMn_{X}O_{Y}), a lithium polyanion, such as a nickel-manganese-cobalt oxide [Li(Ni_{X}Mn_{Y}Co_{Z})O₂], lithium iron phosphate (LiFePO₄), or lithium fluorophosphate (Li₂FePO₄F), or a mixture of any of these materials. Some other suitable lithium-based active materials that may be employed as all or part of the lithium-based active material include lithium nickel oxide (LiNiO₂), lithium aluminum manganese oxide (Li_{X}Al_{Y}Mn_{1-Y}O₂) and lithium vanadium oxide (LiV₂O₅), to name but a few alternatives. The positive-side metallic current collector associated with the positive electrode 12 is preferably a thin-film aluminum foil that coextensively contacts the outer face surface of the positive electrode 12.

The separator 13 functions as a thin and electrically insulative mechanical barrier layer that physically separates the confronting inner face surfaces of the electrodes 11, 12 to prevent a short-circuit in the electrochemical battery cell 10. The separator 13 is also sufficiently porous to permit infiltration of the liquid electrolyte solution and the internal passage of dissolved lithium ions.

The liquid electrolyte solution infiltrated into the separator 13, and which wets both electrodes 11, 12, is preferably a lithium salt dissolved in a non-aqueous solvent. Some suitable lithium salts that may be used to make the liquid electrolyte solution include LiClO₄, LiAlCl₄, LiI, LiBr, LiSCN, LiBF₄, LiB(C₆H₅)₄, LiAsF₆, LiCF₃SO₃, LiN(CF₃SO₂)₂, LiPF₆, and a mixture that includes one or more of these salts. The non-aqueous solvent in which the lithium salt is dissolved may be a cyclic carbonate (i.e., ethylene carbonate, propylene carbonate), an acyclic carbonate (i.e., dimethyl carbonate, diethyl carbonate, ethylmethylcarbonate), an aliphatic carboxylic ester (i.e., methyl formate, methyl acetate, methyl propionate), a γ-lactone (i.e., γ-butyrolactone, γ-valerolactone), an acyclic ether (i.e., 1,2-dimethoxyethane, 1,2-diethoxyethane, ethoxymethoxyethane), a cyclic ether (i.e., tetrahydrofuran, 2-methyltetrahydrofuran), or a mixture that includes one or more of these solvents.

As shown, the negative and positive terminals 15, 17 of the lithium ion battery 9 may be connected to an electrical device 18 that generally encompasses power-consuming and power-generating devices. A power-consuming device is one that is powered fully or partially by the lithium ion battery 9 when operating in a discharge state. Conversely, a power-generating device is one that charges or re-powers the lithium ion battery 9. The power-consuming device and the power-generating device can be the same device in some instances. For example, the electrical device 18 may be an electric motor for a hybrid electric or an extended range electric vehicle that is designed to draw an electric current from the lithium ion battery 9 during acceleration and provide a regenerative electric current to the lithium ion battery 9 during deceleration. The power-consuming device and the power-generating device can also be different devices. For example, the power-consuming device may be an electric motor for a hybrid electric or an extended range electric vehicle and the power-generating device may be an AC wall outlet, an internal combustion engine, and/or a vehicle alternator.

The lithium ion battery 9 can provide a useful electrical current to the electrical device 18 by way of reversible electrochemical reactions that occur in the electrochemical battery cell 10 when a closed-circuit connects the negative terminal 15 and the positive terminal 17 at a time when the negative electrode 11 contains a sufficient quantity of intercalated lithium (i.e., battery discharge). The electrochemical potential difference between the negative electrode 11 and the positive electrode 12 drives the oxidation of intercalated lithium contained in the negative electrode 11. Free electrons produced by this oxidation reaction are collected by the negative-side current collector and supplied to the negative terminal 15. A flow of free electrons is harnessed and directed through the electrical device 18 from the negative terminal 15 to the positive terminal 17 and eventually to the positive electrode 12 by way of the positive-side current collector. Lithium ions, which are also produced at the negative electrode 11, are concurrently carried through the separator 13 by the liquid electrolyte solution in route to the positive electrode 12. The flow of free electrons through the electrical device 18 from the negative terminal 15 to the positive terminal 17 can be continuously or intermittently provided until the negative electrode 11 is depleted of intercalated lithium and the capacity of the electrochemical battery cell 10 is spent.

The lithium ion battery 9 can be charged or re-powered at any time by applying an external voltage originating from the electrical device 18 to the electrochemical battery cell 10 to reverse the electrochemical reactions that occur during discharge. The applied external voltage compels the otherwise non-spontaneous oxidation of intercalated lithium contained in the positive electrode 12 to produce free electrons and lithium ions. The free electrons are collected by the positive-side current collector 24 and supplied to the positive terminal 17. A flow of the free electrons is directed to the negative terminal 15 and eventually to the negative electrode 11 by way of the negative-side current collector. The lithium ions are concurrently carried back through the separator 13 in the liquid electrolyte solution towards the negative electrode 11. The lithium ions and the free electrons eventually reunite and replenish the negative electrode 11 with intercalated lithium to prepare the electrochemical battery cell 10 for another discharge phase.

FIG. 3 provides an exploded cross-sectional view of a single exemplary electrochemical battery cell 20, such as one of the cells 10 described in the battery 9 of FIG. 2. FIG. 3 further illustrates the associated metallic current collectors.

In FIG. 3, the exemplary battery cell 20 is a lithium ion electrochemical cell including a negative electrode 22 (anode on discharge), a positive electrode 24 (cathode on discharge), and a porous separator 26 disposed between the two electrodes 22, 24. The porous separator 26 includes an electrolyte system 30, which may also be present in the negative electrode 22 and positive electrode 24. A negative electrode current collector 32 may be positioned at or near the negative electrode 22 and a positive electrode current collector 34 may be positioned at or near the positive electrode 24. The negative electrode current collector 32 and positive electrode current collector 34 respectively collect and move free electrons to and from an external circuit 40. An interruptible external circuit 40 and load device 42 connects the negative electrode 22 (through its current collector 32) and the positive electrode 24 (through its current collector 34).

The porous separator 26 operates as both an electrical insulator and a mechanical support, by being sandwiched between the negative electrode 22 and the positive electrode 24 to prevent physical contact and thus, the occurrence of a short circuit. The porous separator 26, in addition to providing a physical barrier between the two electrodes 22, 24, can provide a minimal resistance path for internal passage of lithium ions (and related anions) during cycling of the lithium ions to facilitate functioning of the battery cell 20. In lithium ion batteries, lithium intercalates and/or alloys in the electrode active materials.

The battery cell 20 can be charged or re-energized at any time by connecting an external power source to the battery cell 20 to reverse the electrochemical reactions that occur during battery discharge. The connection of an external power source to the battery cell 20 compels the production of electrons and release of lithium ions from the positive electrode 24. The electrons, which flow back towards the negative electrode 22 through the external circuit 40, and the lithium ions, which are carried by the electrolyte system 30 across the separator 26 back towards the negative electrode 22, reunite at the negative electrode 22 and replenish it with lithium for consumption during the next battery discharge cycle. As such, each discharge and charge event is considered to be a cycle, where lithium ions are cycled between the positive electrode 24 and negative electrode 22.

The external power source that may be used to charge the battery cell 20 may vary depending on the size, construction, and particular end-use of the battery cell 20. Some notable and exemplary external power sources include, but are not limited to, an AC wall outlet and a motor vehicle alternator. In many lithium ion battery configurations, each of the negative current collector 32, negative electrode 22, the separator 26, positive electrode 24, and positive electrode current collector 34 are prepared as relatively thin layers (for example, from several microns to a millimeter or less in thickness) and assembled in layers connected in electrical parallel arrangement to provide a suitable electrical energy and power package.

Furthermore, the battery cell 20 can include a variety of other components that while not depicted here are nonetheless known to those of skill in the art. For instance, the battery cell 20 may include a casing, gaskets, terminal caps, tabs, battery terminals, and any other conventional components or materials that may be situated within the battery cell 20, including between or around the negative electrode 22, the positive electrode 24, and/or the separator 26. As noted above, the size and shape of the battery cell 20 may vary depending on the particular application for which it is designed. Battery-powered vehicles and hand-held consumer electronic devices, for example, are two examples where the battery cell 20 would most likely be designed to different size, capacity, and power-output specifications. The battery cell 20 may also be connected in series or parallel with other similar lithium ion cells or batteries to produce a greater voltage output, energy, and power if it is required by the load device 42.

Accordingly, the battery cell 20 can generate electric current to a load device 42 that can be operatively connected to the external circuit 40. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances. The load device 42 may also be a power-generating apparatus that charges the battery cell 20 for purposes of storing energy. In certain other variations, the electrochemical cell may be a supercapacitor, such as a lithium ion based supercapacitor.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP.

When the porous separator 26 is a microporous polymeric separator, it may be a single layer or a multi-layer laminate, which may be fabricated from either a dry or wet process. For example, in one embodiment, a single layer of the polyolefin may form the entire microporous polymer separator 26. In other aspects, the separator 26 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 26. Furthermore, the porous separator 26 may be mixed with a ceramic material or its surface may be coated in a ceramic material. For example, a ceramic coating may include alumina (Al₂O₃), silicon dioxide (SiO₂), or combinations thereof. Various conventionally available polymers and commercial products for forming the separator 26 are contemplated, as well as the many manufacturing methods that may be employed to produce such a microporous polymer separator 26.

In various aspects, the positive electrode 24, the negative electrode 22, and the separator 26 may each include an electrolyte solution or system 30, capable of conducting lithium ions between the negative electrode 22 and the positive electrode 24. The electrolyte system 30 may be a non-aqueous liquid electrolyte solution that includes one or more lithium salts dissolved in an organic solvent or a mixture of organic solvents. In certain variations, the electrolyte system 30 may be a 1M solution of one or more lithium salts in one or more organic solvents. Numerous conventional non-aqueous liquid electrolyte system 30 solutions may be employed in the lithium ion battery cell 20.

A non-limiting list of lithium salts that may be dissolved in the one or more organic solvents to form the non-aqueous liquid electrolyte solution include lithium hexafluorophosphate (LiPF₆); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium tetraphenylborate (LiB(C₆H₅)₄); lithium bis(oxalato)borate (LiB(C₂O₄)₂) (LiBOB); lithium difluorooxalatoborate (LiBF₂(C₂O₄)); lithium hexafluoroarsenate (LiAsF₆); lithium trifluoromethanesulfonate (LiCF₃SO₃); lithium trigluoromethanesulfonimide (LiN(CF₃SO₂)₂); lithium bis(fluorosulfonyl)imide (LiN(FSO₂)₂) (LiSFI); and combinations thereof.

These and other similar lithium salts may be dissolved in a variety of organic solvents, including but not limited to, various alkyl carbonates, such as cyclic carbonates (e.g., ethylene carbonate (EC), propylene carbonate (PC), butylene carbonate (BC), fluoroethylene carbonate (FEC)); linear carbonates (e.g., dimethyl carbonate (DMC), diethyl carbonate (DEC), ethylmethylcarbonate (EMC)); aliphatic carboxylic esters (e.g., methyl formate, methyl acetate, methyl propionate), γ-lactones (e.g., γ-butyrolactone, γ-valerolactone); chain structure ethers (e.g., 1,2-dimethoxyethane, 1-2-diethoxyethane, ethoxymethoxyethane); cyclic ethers (e.g., tetrahydrofuran, 2-methyltetrahydrofuran); and combinations thereof.

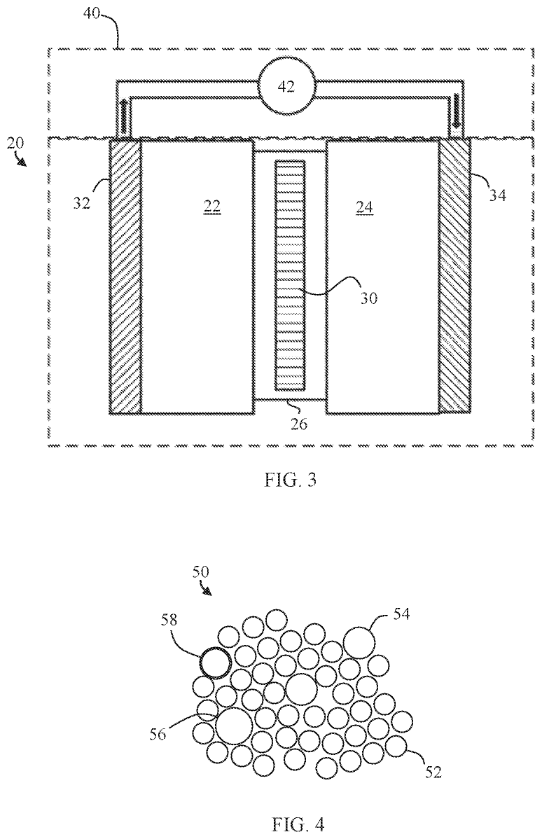

FIG. 4 illustrates cathode material 50 for use in the cathodes 12 of FIG. 2 or the cathode 24 of FIG. 3. As shown, the cathode material 50 is in the formed of a blended mixture of particles. The cathode material 50 may have an olivine, spinel, or rocksalt structure. A first cathode material 52 is a cathode electroactive (“active” as used herein) material, LiFeₓMn₁₋ₓPO₄. A second cathode material 54 is an additional cathode active material. A third cathode material 56 is another additional cathode active material. Collectively, cathode materials 52, 54, and 56 make up the cathode active material in the cathode material 50. Also shown is material 58 which is non-active material. In the illustrated embodiment, the non-active material 58 is shown as a coating on a particle. Non-active material is not limited to coatings and may be present in other forms, such as particles.

In various aspects, the positive electrode or cathode (12 of FIG. 2 or 24 of FIG. 3) may be formed from a lithium-based cathode active material, such as particles 52, 54 or 56 of FIG. 4, that can sufficiently undergo lithium intercalation and deintercalation, alloying and dealloying, or plating and stripping, while functioning as the positive terminal of the battery cell.

In exemplary embodiments, the cathode active material is free of nickel (Ni) and/or free of cobalt (Co). In exemplary embodiments, the cathode active material includes less than 5 wt. %, such as less than 4 wt. %, for example less than 3 wt. %, such as less than 2 wt. %, for example less than 1 wt. %, such as less than 0.5 wt. %, for example less than 0.1 wt. %, such as less than 0.05 wt. % or less than 0.01 wt. %, of nickel (Ni) and/or cobalt (Co), based on a total weight of the cathode active material.

An exemplary cathode active material may include one component, such as particles 52, or may include more than one component, such as two or more components in a blended mixture, such as particles 52, 54 and 56. For example, each component may be provided in the form of particles and the cathode active material may be formed from a blended mixture of the particles of the components. Any suitable number of cathode active materials may be used. Further, any suitable physical form of the cathode active materials may be used.

In exemplary embodiments, the cathode active material includes a lithium iron manganese phosphate (LFMP) oxide. For example, an exemplary cathode active material includes LiFeₓMn₁₋ₓPO₄, wherein x is from 0.01 to 0.5. In exemplary embodiments, x is greater than or equal to 0.01, 0.05, 0.1, 0.15, or 0.2. In exemplary embodiments, x is less than or equal to 0.4, 0.35, 0.3, 0.25, or 0.2. For example, x may be from 0.01 to 0.35, from 0.01 to 0.3, from 0.01 to 0.25, from 0.01 to 0.2, or 0.2. In other words, an exemplary lithium iron manganese phosphate oxide may be LiFe_{0.2}Mn_{0.8}PO₄.

In exemplary embodiments, the cathode active material includes at least 50 wt. %, based on a total weight of the cathode active material, of LiFeₓMn₍₁₋ₓ₎PO₄. An exemplary cathode active material may include at least 60 wt. %, such as at least 65 wt. %, for example at least 70 wt. %, such as at least 75 wt. %, for example at least 80 wt. %, such as at least 85 wt. %, for example at least 90 wt. %, such as at least 95 wt. %, for example at least 99 wt. %, of LiFeₓMn₍₁₋ₓ₎PO₄, based on a total weight of the cathode active material.

In exemplary embodiments, the LiFeₓMn₍₁₋ₓ₎PO₄ is in particle form and has a primary particle size of at least 10 nanometers (nm), such as at least 20 nm, for example at least 30 nm, such as at least 40 nm, for example at least 50 nm, such as at least 60 nm, for example at least 70 nm. As used herein, a component has a defined primary particle size range when 95% of the particles are within the defined range.

In exemplary embodiments, the LiFeₓMn₍₁₋ₓ₎PO₄ is in particle form and has a primary particle size of no more than 200 nm, such as no more than 150 nm, for example no more than 120 nm, such as no more than 100 nm, for example no more than 90 nm, such as no more than 80 nm.

In certain embodiments, the LiFeₓMn₍₁₋ₓ₎PO₄ has a primary particle size of from 10 to 200 nm, such as from 30 to 150 nm, for example from 40 to 90 nm, such as from 50 to 80 nm. Other suitable particle sizes may be utilized.

In addition to the lithium iron manganese phosphate oxide, the cathode active material may also include additional active material. In exemplary embodiments, the additional active material, or a portion thereof, is in particle form and has a primary particle size. In such embodiments, the cathode active material is a blended mixture of particles of lithium iron manganese phosphate oxide and particles of additional active material. For an exemplary cathode active material, the additional active material is selected from lithium manganese oxide (LMO) and/or lithium iron phosphate oxide (LFP) material. An exemplary LMO material is LiMn₂O₄. An exemplary LFP material is LiFePO₄. Other suitable LMO or LFP materials, or other suitable cathode active materials, may be used.

In exemplary embodiments, the additional cathode active material has a primary particle size of at least 50 nm, such as at least 100 nm, for example at least 150 nm or at least 200 nm. In exemplary embodiments, the additional cathode active material has a primary particle size of no more than 900 nm, such as no more than 800 nm, for example no more than 700 nm, such as no more than 600 nm, for example no more than 500 nm, such as no more than 400 nm or no more than 300 nm. For example, the additional cathode active material may have a primary particle size of from 50 to 900 nm, such as from 100 to 800 nm, for example from 200 to 600 nm or 200 to 300 nm. Other suitable particle sizes may be utilized.

In certain exemplary embodiments, the cathode active material includes at least 50 wt. %, such as at least 55 wt. %, for example at least 60 wt. %, such as at least 65 wt. %, for example at least 70 wt. %, such as at least 75 wt. %, for example at least 80 wt. %, such as at least 85 wt. %, for example at least 90 wt. %, such as at least 95 wt. %, for example at least 98 wt. % or at least 99 wt. %, lithium iron manganese phosphate (LFMP) oxide, based on a total weight of the cathode active material.

In certain exemplary embodiments, the cathode active material includes no more than 50 wt. %, such as no more than 45 wt. %, for example no more than 40 wt. %, such as no more than 35 wt. %, for example no more than 30 wt. %, such as no more than 25 wt. %, for example no more than 20 wt. %, such as no more than 15 wt. %, for example no more than 10 wt. %, such as no more than 5 wt. %, for example no more than 2 wt. % or no more than 1 wt. %, additional active material, based on a total weight of the cathode active material.

In exemplary embodiments, the cathode active material is from 50 to 99 wt. % lithium iron manganese phosphate (LFMP) oxide and from 1 to 50 wt. % of the additional active material, based on a total weight of the cathode active material. For example, the cathode active material may comprise from 70 to 99 wt. % lithium iron manganese phosphate (LFMP) oxide and from 1 to 30 wt. % of the additional active material, based on a total weight of the cathode active material. In certain exemplary embodiments, the cathode active material comprises 70 wt. % lithium iron manganese phosphate (LFMP) oxide and 30 wt. % of the additional active material, based on a total weight of the cathode active material.

An exemplary cathode active material comprises a blended mixture of the lithium iron manganese phosphate oxide (LFMP) material and the lithium manganese oxide (LMO) material and has a selected LFMP:LMO mass ratio. In exemplary embodiments, the LFMP:LMO mass ratio is at least 50:50, such as at least 60:40, for example at least 70:30, such as at least 80:20, for example at least 90:10 or at least 95:5. In exemplary embodiments, the LFMP:LMO mass ratio is at most 99:1, such as at most 95:5, for example at most 90:10, such as at most 80:20, for example at most 70:30 or at most 60:40. For example, the LFMP:LMO mass ratio may be from 60:40 to 95:5, such as from 80:20 to 95:5. Other suitable LFMP:LMO mass ratios may be utilized.

In addition to the cathode active material, an exemplary cathode may also include non-active (non-electroactive) material. Specifically, the cathode active material may be intermingled with an optional electrically conductive material and at least one polymeric binder material to structurally fortify the lithium-based active material along with an optional electrically conductive particle distributed therein. For example, the active materials and optional conductive materials may be slurry cast with such non-active binders or binder resins, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), lithium polyacrylate (LiPAA), sodium polyacrylate (NaPAA), sodium alginate, lithium alginate, fluorine rubber, or the like, and mixtures thereof. Other suitable binder resins may be used.

An inorganic conductive binder may be selected from activated carbon, carbon black, carbon nanotube, carbon nanowire, carbon nanoparticles, and chemically modified particles thereof. In certain embodiments, all or a portion of the active cathode material is coated with the inorganic conductive binder. Other suitable inorganic conductive binders may be used. Other electrically conductive materials may be used and include graphite, carbon-based materials, metal particles, or a conductive polymer. Carbon-based materials may include by way of non-limiting example particles of KETCHEN™ black, DENKA™ black, acetylene black, carbon black, and the like. Examples of a conductive polymer include polyaniline, polythiophene, polyacetylene, polypyrrole, and the like. In certain aspects, mixtures of conductive materials may be used.

An exemplary cathode includes at least about 85 wt. % of active cathode material, such as at least 90 wt. % of active cathode material, for example at least 95 wt. % of active cathode material, such as at least 97 wt. % of active cathode material, based on a total weight of the cathode material. In such embodiments, the remaining portion of the cathode is non-active cathode material. In an exemplary embodiment, the cathode comprises at least 95 wt. % active material, at least 1 wt. % inorganic conductive binder, such as carbon nanotube, and at least 1 wt. % binder resin, such as PVdF, based on a total weight of the cathode material. For example, an exemplary cathode comprises 97 wt. % active material, 1.5 wt. % inorganic conductive binder, such as carbon nanotube, and 1.5 wt. % binder resin, such as PVdF, based on a total weight of the cathode material. Other suitable compositional percentages may be used. In exemplary embodiments, the cathode comprises less than 2 wt. % polymer binder or binder resin, such as less than 1.5 wt. %, for example less than 1.0 wt. %, such as less than 0.75 wt. %, for example less than 0.5 wt. %, such as less than 0.25 wt. %, for example less than 0.1 wt. % or less than 0.05 wt. % polymer binder or binder resin. In exemplary embodiments, the cathode is free of polymer binder or binder resin, i.e., includes no polymer binder or binder resin.

In exemplary embodiments, the cathode active material has a reversible capacity loading of not less than 4.0 mAh/cm², such as not less than 4.5 mAh/cm², for example not less than 4.8 mAh/cm².

In exemplary embodiments, the cathode active material has an electrode porosity of not greater than 35%, such as not greater than 30%, for example not greater than 25%.

In exemplary embodiments, the lithium ion battery cells are operated at a temperature of from −30 to 80° C., such as from −10 to 80° C.; for example from 10 to 80° C., such as from 30 to 80° C., for example from 40 to 70° C. In exemplary embodiments, the lithium ion battery cells are operated at a temperature of from 30 to 55° C., such as from 35 to 45° C.

In exemplary embodiments, the lithium ion battery cell with the cathode active material has an energy density of at least 500 Wh/L, such as at least 510 Wh/L, for example at least 520 Wh/L or at least 530 Wh/L.

In exemplary embodiments, the lithium ion battery cell with the cathode active material has a specific energy of at least 240 Wh/kg, such as at least 250 Wh/kg, for example at least 255 Wh/kg.

In exemplary embodiments, the cathode active material has an energy density of at least 600 Wh/kg, such as 610 Wh/kg.

In exemplary embodiments, the cathode active material has a capacity of at least 150 mAh/g, such as from 150 mAh/g to 155 mAh/g.

In exemplary embodiment, the cathode active material provides for lithium diffusivity of at least 10⁻¹⁵ cm²/s and for electric conductivity of at least 10⁻¹³ S/cm.

Cross-referencing FIGS. 1-4, an electric vehicle 1 is described and includes a vehicle chassis 3 and at least one battery pack assembly 7 including lithium ion cells 10. In exemplary embodiments, at least 50% of the lithium ion cells 10 provided in the battery pack assembly 7 have a cathode 12 comprising a cathode active material of at least 50 wt. %, based on a total weight of the described LFMP cathode active material. In exemplary embodiments, at least 55%, such as at least 60%, for example at least 65%, such as at least 70%, for example at least 75%, such as at least 80%, for example at least 85%, such as at least 90% or at least 95% of the lithium ion cells 10 provided in the battery pack assembly 7 have a cathode comprising the described LFMP cathode active material. In exemplary embodiments, 100% of the lithium ion cells 10 provided in the battery pack assembly 7 may have a cathode comprising the described LFMP cathode active material. In exemplary embodiments, less than 95%, such as less than 90%, for example less than 85%, such as less than 80%, for example less than 75%, such as less than 70%, for example less than 65% or less than 60%, of the lithium ion cells 10 provided in the battery pack assembly 7 have a cathode comprising the described LFMP cathode active material.

Generally, the battery power capability for EVs is not high. While driving an EV, the discharge rate could be less than C/3 (3 hours to discharge the cells). Thus, the batteries described herein are well suited for use in EVs.

Because LFMP cathode active material has poor power capability (slow diffusion rate and poor electric conductivity), it has not been used with high capacity loading (capacity loading: ≥4.0 mAh/cm²), such as that required for EV applications. As described herein, a LFMP cathode active material, paired with a graphite anode, is used for EV applications even with high capacity loading (≥4.0 mAh/cm² or even ≥4.5 mAh/cm² or ≥4.8 mAh/cm²). In certain exemplary embodiments, the EV battery is operated at relatively high temperature, such as higher than 30° C. In those embodiments it is believed that the high temperature improves the diffusion rate to improve the power capability of the EV battery.

In certain exemplary embodiments, the LFMP cathode active material is blended with LMO active material to obtain a high power capability. As another nickel-free and cobalt-free material, costs of an EV battery containing LFMP and LMO is not subject to increased costs of nickel or cobalt.

In certain exemplary embodiments, the cathode does not include polymer binder or binder resin. Generally, polymer binder reduces the power capability by increasing the interface resistance at the electrolyte/cathode active material interface. Power capability of LFMP is improved by avoiding use of polymer binder. Rather, exemplary embodiments use an inorganic binder hold the cathode materials together. An exemplary inorganic binder is modified carbon, such as modified carbon particles.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A lithium ion battery for an electric vehicle, the lithium ion battery comprising:
a cathode including a cathode active material comprising at least about 50 wt. %, based on a total weight of the cathode active material, of LiFeₓMn₍₁₋ₓ₎PO₄, wherein X is from about 0.01 to about 0.5.

2. The lithium ion battery of claim 1 wherein the cathode active material further comprises additional active material selected from LiMn₂O₄ and/or LiFePO₄.

3. The lithium ion battery of claim 1 wherein the cathode active material further comprises additional active material selected from a lithium manganese oxide (LMO) material and a lithium iron phosphate (LFP) material, wherein the cathode active material comprises from about 50 to about 99 wt. % LiFeₓMn₍₁₋ₓ₎PO₄ and from 1 to about 50 wt. % of the additional active material, all based on a total weight of the cathode active material.

4. The lithium ion battery of claim 1 wherein the cathode further comprises an inorganic conductive binder.

5. The lithium ion battery of claim 1 wherein the cathode further comprises an inorganic binder and a binder resin, wherein the cathode comprises:
at least about 95 wt. % active material;
at least about 1 wt. % carbon nanotube; and
at least about 1 wt. % binder resin.

6. The lithium ion battery of claim 1 wherein the cathode active material has a reversible capacity loading of not less than 4.0 mAh/cm².

7. The lithium ion battery of claim 1 wherein the cathode active material has an electrode porosity of not greater than 35%.

8. A lithium ion battery comprising:
a cathode including a cathode active material comprising a blended mixture of a lithium manganese oxide (LMO) material and LiFeₓMn₍₁₋ₓ₎PO₄, wherein X is at most 0.5; and wherein the cathode active material has a LiFeₓMn₍₁₋ₓ₎PO₄:LMO material mass ratio of from about 60:40 to about 95:5.

9. The lithium ion battery of claim 8 wherein the LMO material is LiMn₂O₄.

10. The lithium ion battery of claim 8 wherein X=0.2 and Y=0.8.

11. The lithium ion battery of claim 8 wherein the LiFeₓMn₍₁₋ₓ₎PO₄:LMO material mass ratio is from about 60:40 to about 70:30.

12. The lithium ion battery of claim 8 wherein the LiFeₓMn₍₁₋ₓ₎PO₄:LMO material mass ratio is from about 70:30 to about 80:20.

13. The lithium ion battery of claim 8 wherein the LiFeₓMn₍₁₋ₓ₎PO₄:LMO material mass ratio is from about 80:20 to about 95:5.

14. An electric vehicle comprising:
a vehicle chassis; and
a battery pack assembly including lithium ion cells, wherein at least 50% of the lithium ion cells have a cathode comprising a cathode active material of at least about 50 wt. %, based on a total weight of the cathode active material, of LiFeₓMn₍₁₋ₓ₎PO₄, wherein X is from about 0.01 to about 0.5.

15. The electric vehicle of claim 14 wherein at least 70% of the lithium ion cells have a cathode comprising the cathode active material.

16. The electric vehicle of claim 14 wherein at least 90% of the lithium ion cells have a cathode comprising the cathode active material.

17. The electric vehicle of claim 14 wherein the cathode active material comprises a blended mixture of a lithium manganese oxide (LMO) material and the LiFeₓMn₍₁₋ₓ₎PO₄; and wherein the cathode active material has a LiFeₓMn₍₁₋ₓ₎PO₄:LMO material mass ratio of from about 60:40 to about 95:5.

18. The electric vehicle of claim 17 wherein the LMO material is LiMn₂O₄.

19. The electric vehicle of claim 18 wherein X=0.2 and Y=0.8.

20. The electric vehicle of claim 14 wherein the lithium ion cells have a cathode reversible capacity loading of greater than 4.0 mAh/cm², and wherein the lithium ion cells are operated at a temperature from about −30 to about 80° C.
